(19) United States
(12) Patent Application Publication
(10) Pub. No.: US 2026/0161428 A1
(43) Pub. Date: Jun. 11, 2026

(54) TILE SPECIFICATION GENERATION FOR DYNAMIC USER INTERFACE TILES

(71) Applicant: Capital One Services, LLC, McLean, VA (US)

(72) Inventors: Christopher DELIA, New Market, MD (US); Amit SHARMA, Vienna, VA (US); Mengda QI, Chicago, IL (US); Annu BATRA, Glen Allen, VA (US); Devendra NATEKAR, Vienna, VA (US)

(21) Appl. No.: 19/209,291

(22) Filed: May 15, 2025

Related U.S. Application Data
(60) Provisional application No. 63/728,487, filed on Dec. 5, 2024.
(60) Provisional application No. 63/728,476, filed on Dec. 5, 2024.
(60) Provisional application No. 63/728,494, filed on Dec. 5, 2024.

(51) Int. Cl. G06F 9/451

(52) U.S. Cl. CPC G06F 9/451

(57) ABSTRACT

In some implementations, a system may obtain, via a first user interface, an arrangement of one or more user interface elements for a dynamic user experience. The system may obtain one or more prototype templates for the arrangement of one or more user interface elements, wherein the one or more prototype templates include rendering information for a second user interface. The system may generate, based on the arrangement and the one or more prototype templates, one or more tile specifications for the dynamic user experience. The system may store the one or more tile specifications in a data structure in association with the dynamic user experience.

### CROSS-REFERENCE TO RELATED APPLICATIONS

This Patent Application claims priority to U.S. Provisional Patent Application No. 63/728,487, filed on Dec. 5, 2024, and entitled “CAPABILITY NEGOTIATION FOR DYNAMIC USER INTERFACE TILES,” to U.S. Provisional Patent Application No. 63/728,476, filed on Dec. 5, 2024, and entitled “EXPERIENCE CONFIGURATION FOR DYNAMIC USER INTERFACE TILES,” and to U.S. Provisional Patent Application No. 63/728,494, filed on Dec. 5, 2024, and entitled “RESOLVING AND HYDRATING DYNAMIC TILE SPECIFICATIONS.” The disclosures of the prior Applications are considered part of and are incorporated by reference into this Patent Application.

### BACKGROUND

A graphical user interface is a form of user interface that allows users to interact with electronic devices. A web browser or application executing on a client device may provide a graphical user interface that presents one or more pages. A user may navigate to a page by entering a web address into an address bar of the web browser and/or by clicking a link displayed via another page. Navigation to a page may consume resources of a client device on which the web browser is installed or the application is executing, may consume resources of a server that serves the page to the client device, and/or may consume network resources used for communications between the client device and the server.

### SUMMARY

Some implementations described herein relate to a system for tile specification generation for dynamic user interface tiles. The system may include one or more memories and one or more processors communicatively coupled to the one or more memories. The one or more processors may be configured to obtain, via a first user interface, an arrangement of one or more user interface elements for a dynamic user experience. The one or more processors may be configured to obtain one or more prototype templates for the arrangement of one or more user interface elements, wherein the one or more prototype templates include rendering information for a second user interface. The one or more processors may be configured to generate, based on the arrangement and the one or more prototype templates, one or more tile specifications for the dynamic user experience. The one or more processors may be configured to store the one or more tile specifications in a data structure in association with the dynamic user experience. The one or more processors may be configured to transmit, to a client device and based on a client request, the one or more tile specifications to cause the client device to display the dynamic user experience via the second user interface.

Some implementations described herein relate to a method for tile specification generation for dynamic user interface tiles. The method may include obtaining, by a system and via a first user interface, an arrangement of one or more user interface elements for a dynamic user experience. The method may include obtaining, by the system, one or more prototype templates for the arrangement of one or more user interface elements, wherein the one or more prototype templates include rendering information for a second user interface. The method may include generating, by the system and based on the arrangement and the one or more prototype templates, one or more tile specifications for the dynamic user experience. The method may include storing, by the system, the one or more tile specifications in a data structure in association with the dynamic user experience.

Some implementations described herein relate to a non-transitory computer-readable medium that stores a set of instructions. The set of instructions, when executed by one or more processors of a system, may cause the system to obtain, via a first user interface, an arrangement of one or more user interface elements for a dynamic user experience. The set of instructions, when executed by one or more processors of the system, may cause the system to obtain one or more prototype templates for the arrangement of one or more user interface elements, wherein the one or more prototype templates include rendering information for a second user interface. The set of instructions, when executed by one or more processors of the system, may cause the system to generate, based on the arrangement and the one or more prototype templates, one or more tile specifications for the dynamic user experience. The set of instructions, when executed by one or more processors of the system, may cause the system to store the one or more tile specifications in a data structure in association with the dynamic user experience.

### BRIEF DESCRIPTION OF THE DRAWINGS

FIGS. 1A-1D are diagrams of an example associated with tile specification generation for dynamic user interface tiles, in accordance with some embodiments of the present disclosure.

FIG. 2 is a diagram of an example associated with a design user interface for tile specification generation for dynamic user interface tiles, in accordance with some embodiments of the present disclosure.

FIG. 3 is a diagram of an example associated with a tile specification for dynamic user interface tiles, in accordance with some embodiments of the present disclosure.

FIG. 4 is a diagram of an example associated with a tile provider system for dynamic user interface tiles, in accordance with some embodiments of the present disclosure.

FIG. 5 is a diagram of an example environment in which systems and/or methods described herein may be implemented, in accordance with some embodiments of the present disclosure.

FIG. 6 is a diagram of example components of a device associated with tile specification generation for dynamic user interface tiles, in accordance with some embodiments of the present disclosure.

FIG. 7 is a flowchart of an example process associated with tile specification generation for dynamic user interface tiles, in accordance with some embodiments of the present disclosure.

### DETAILED DESCRIPTION

The following detailed description of example implementations refers to the accompanying drawings. The same reference numbers in different drawings may identify the same or similar elements.

A user interface of a client device may include a page for presentation via the client device. The user interface may include one or more graphical elements (e.g., for a graphical user interface (GUI)) that are configured to enable a user to interact with the client device (e.g., rather than using text-based commands or other commands). The graphical element(s) may include icons, visual indicators, buttons, menus, windows, text, interactive components, links, and/or visual elements, among other examples. The graphical elements may enable different user experiences to be provided for display to the user via the GUI. As used herein, “user experience” refers to a manner and/or design in which information is presented to a user via one or more graphical elements of a GUI. A user experience may include a design (e.g., a size, a shape, and/or content being displayed) and/or layout of one or more graphical elements. A user experience may be evaluated based on one or more factors, such as usability, accessibility, visual design, responsiveness, and/or ease of navigation, among other examples. For example, a user experience may be designed to make the GUI intuitive, efficient, and/or enjoyable for a user to accomplish a goal. Therefore, improved user experiences for a GUI may reduce the amount of navigation performed by the user via the client device to accomplish the goal, thereby conserving processing resources, network resources, and/or power resources, among other examples, that would have otherwise been associated with additional navigation via the client device. Further, improved user experiences for a GUI may make data easier to access by enhancing the GUI, thereby enhancing user-friendliness of the client device and the GUI, and improving the ability of the user to use the client device, among other examples.

In some cases, a user experience may be changed or redesigned over time (e.g., to improve the performance and/or effectiveness of the user experience). However, the user experience may be provided via multiple channels that use respective interfaces (e.g., GUIs or other interfaces) to provide the user experience for display (e.g., where each channel is configured for a specific platform while maintaining the design and interactions of the user experience). For example, the multiple channels may include one or more applications (e.g., a web application or a mobile application), a web page, and/or a program (e.g., executing on the client device), among other examples. Additionally, a given channel may be associated with multiple variations or types. For example, a mobile application may be deployed via multiple operating systems that have different design conventions, use different formats, have application programming interface (API) details, and/or support different hardware, among other examples.

Therefore, it may be difficult to maintain consistency when updating or changing a user experience across multiple channels because of the channel-specific (or operating system-specific) differences. For example, it may be difficult to maintain a uniform design and functionality across various platforms (e.g., web, mobile, and/or desktop) that may have different user interface guidelines, technical limitations, and/or performance characteristics. Additionally, when deploying updates for mobile applications, the process may be more complex due to the different requirements of different operating systems. Further, an application may be associated with different versions. Different users may be using different versions of the application, introducing additional complexity associated with deploying the updated user experience across different versions of the same application (e.g., where the different versions may support different features). Additionally, ensuring synchronization of features, performance, and/or updates across all channels without introducing inconsistencies or bugs can be a time-consuming and resource-intensive process. As a result, updating a user experience may consume significant processing resources and/or time associated with designing, configuring, deploying, and/or testing the user experience separately for each channel (and/or for each operating system for a given channel).

In some examples, an update to a user experience may be deployed by deploying updated code for the GUI, such as by updating hypertext markup language (HTML) code. This may include updating the HTML structure for a GUI, such as a layout, content, and/or markup, among other examples. However, in such examples, the updated code may be deployed at a server device and provided to a client device when the client device requests a given user experience. As a result, the user experience (e.g., configured or deployed using the updated code) may not have the same look and feel as the rest of the GUI because the updated code may not use native components of the client device.

In some implementations described herein, a system may provide user experiences in an omni-channel manner using a specification (e.g., referred to herein as a “tile specification” or a “dynamic tile definition”). The tile specification may define a user interface component using a specification language (e.g., a dynamic tile language in JavaScript object notation (JSON)). The system (e.g., one or more server devices) may transmit, and a client device may receive, the tile specification. The client device may render a tile based on the tile specification and use one or more native components to display a tile via a GUI. As used herein, “tile” or “user interface tile” refers to a graphical element that represents an application, function, and/or piece of content, among other examples, within a digital interface, such as a GUI. A tile may be “dynamic” in that the design of the tile, the content presented or displayed via the tile, a function of the tile, and/or a link presented or displayed via the tile, among other examples, may vary over time (e.g., depending on a user experience requested, attributes of the user and/or client device, and/or other factors).

By the system using the tile specification to define the manner in which a user experience is to be displayed via a user interface, the system can dynamically update the user experience by changing information in the tile specification. This enables the system to quickly and easily deploy updates for the user experience because a client device may be configured to obtain the tile specification, extract information from the tile specification, and render the tile using native components to generate the tile for the GUI to be displayed by the client device. This ensures that the tile will be generated in accordance with requirements and/or formats of a given channel because the tile is rendered at the client device (e.g., and is not deployed and/or configured using more complex updates and/or schemes).

In some examples, when a new user experience is configured or an existing user experience is updated or modified, one or more tile specifications may be created for the user experience. For example, a design team may design the user experience. For example, the design team may select a layout or configuration of one or more user interface elements for the user experience. Additionally, the design team may determine content to be displayed via one or more user interface elements, one or more actions to be performed when a user interface element is selected, one or more images to be displayed via one or more user interface elements, among other examples. A backend team may generate the one or more tile specifications based on the design provided by the design team. For example, because a tile specification includes code written in a specification language, specialized knowledge is needed to create or generate a tile specification. Therefore, the backend team (e.g., which includes one or more users who possess the specialized knowledge of the specification language) may generate the one or more tile specifications based on the design provided by the design team.

However, this consumes processing resources, network resources, and/or memory resources associated with one or more devices communicating the design for the user experience between the design team and the backend team. Additionally, because the backend team may not possess the knowledge and/or intent behind the design of the user experience, this increases the likelihood of revisions or changes needing to be made to the one or more tile specifications. For example, the backend team may generate one or more initial tile specifications based on the design. However, after testing the one or more initial tile specifications, the design team may provide feedback indicating one or more changes to the user experience that is rendered based on the one or more initial tile specifications. The backend team may modify the one or more tile specifications such that the one or more tile specifications render a user experience in accordance with the feedback. In some examples, there may be multiple rounds of feedback and revisions between the design team and the backend team. This consumes processing resources, network resources, and/or memory resources, among other examples, associated with generating the tile specification(s) for the user experience. Additionally, this increases a delay in the amount of time between when a user experience is designed or modified by the design team and when the user experience can be provided to one or more client devices. For example, each time a user experience is added or modified, there similar interaction between the design team and the backend team to create and/or update one or more tile specifications for the user experience (e.g., because of the specialized knowledge needed to create and/or update one or more tile specifications that may not be possessed by the design team).

Some implementations described herein enable enhanced tile specification generation for dynamic user interface tiles. In some examples, a tile provider system may automatically generate one or more tile specifications based on an arrangement of one or more user interface elements for a dynamic user experience. For example, the tile provider system may provide, for display via a design user interface (e.g., a first user interface), one or more interactive user interface elements. The one or more interactive user interface elements may enable a user (e.g., a designer) to input tile information for a user experience. The tile information may include the arrangement of one or more user interface elements, content to be displayed via the one or more user interface elements, and/or one or more images to be displayed, among other examples. The tile provider system may obtain, from a user device, the tile information that is input via the design user interface.

The tile provider system may generate one or more tile specifications for the dynamic user experience based on the tile information (e.g., based on the arrangement of one or more user interface elements). For example, the tile provider system may obtain one or more prototype templates for respective user interface elements of the one or more user interface elements. A prototype template may include rendering information for a client user interface (e.g., for a second user interface). The rendering information may be written in the specification language. In some examples, a prototype template may be, or may include, at least a portion of a user interface tile template, as described in more detail elsewhere herein. For example, the tile provider system may identify the one or more prototype templates based on the tile information. For example, one or more prototype templates may be mapped to, or otherwise associated with, a given user interface element (e.g., in a prototype set registry). The tile provider system may search for, or otherwise identify, the one or more prototype templates based on the arrangement of user interface elements indicated by the tile information.

The tile provider system may generate, based on the arrangement and the one or more prototype templates, one or more tile specifications for the dynamic user experience. For example, the tile provider system may obtain one or more specification templates based on the one or more user interface elements. For example, the one or more specification templates may be mapped to, or otherwise associated with, the arrangement of the one or more user interface elements. The tile provider system may populate the rendering information (e.g., obtained from the one or more prototype templates) in the one or more specification templates to generate the one or more tile specifications. For example, the tile provider system may populate the rendering information into fields or portions of the one or more specification templates based on the arrangement of the one or more user interface elements. In some examples, the tile provider system may populate other information (e.g., content, image source information, or other information) indicated by the tile information into the one or more specification templates. The tile provider system populating the rendering information in the one or more specification templates may result in the one or more tile specifications for the dynamic user experience. In some implementations, the tile provider system may provide, for display via the design user interface, a prototype view of the dynamic user experience that is based on a rendering of the one or more tile specifications generated by the tile provider system.

The tile provider system may store the one or more tile specifications in a data structure (e.g., a tile registry) in association with the dynamic user experience (e.g., based on performing a successful validation operation), such is with an identifier of the dynamic user experience. The tile provider system may receive, from a client device, a client request for the dynamic user experience. The tile provider system may obtain, from the data structure, the one or more tile specifications. The tile provider system may transmit, to the client device, the one or more tile specifications to cause the client device to display the dynamic user experience via a client user interface (e.g., a second user interface). For example, the client device may render display information for the client user interface based on the one or more tile specifications, as described in more detail elsewhere herein.

As a result, the tile provider system may enable seamless tile specification generation for a dynamic user experience. For example, by the tile provider system enabling a user device to display the design user interface, a user (e.g., a designer) can design and cause the generation of a tile specification through an interaction with the design user interface. For example, by the tile provider system obtaining the tile information, the tile provider system can generate one or more tile specifications based on the tile information (e.g., using one or more prototype templates and/or one or more specification templates). This conserves processing resources, network resources, memory resources, and/or time among other examples, that would have otherwise been associated with a member of a backend team obtaining a design and manually generating the one or more tile specifications by coding in the specification language. Additionally, by the tile provider system providing a prototype view of the dynamic user experience for display via the design user interface, a user (e.g., a designer) can view a rendering of the dynamic user experience while designing the user experience. This reduces the likelihood of the designer providing feedback or changes to the rendered view of the dynamic user experience because the designer can view the prototype view in the same user interface that the tile information is input. As a result, the tile provider system may conserve processing resources, network resources, memory resources, and/or time among other examples, that would have otherwise been associated with communicating feedback, updating one or more tile specifications, and/or communicating the updated tile specification(s), among other examples for one or more rounds of revisions or updates to the one or more tile specifications.

Further, by the tile provider system automatically generating one or more tile specifications based on an arrangement of one or more user interface elements provided via the design user interface, the dynamic user experience can be provided by a client device sooner. The reduced amount of time for the client device providing the dynamic user experience may improve a user experience, make data easier to access by enhancing the client user interface, and/or enhance user-friendliness of a client device and the client user interface, among other examples.

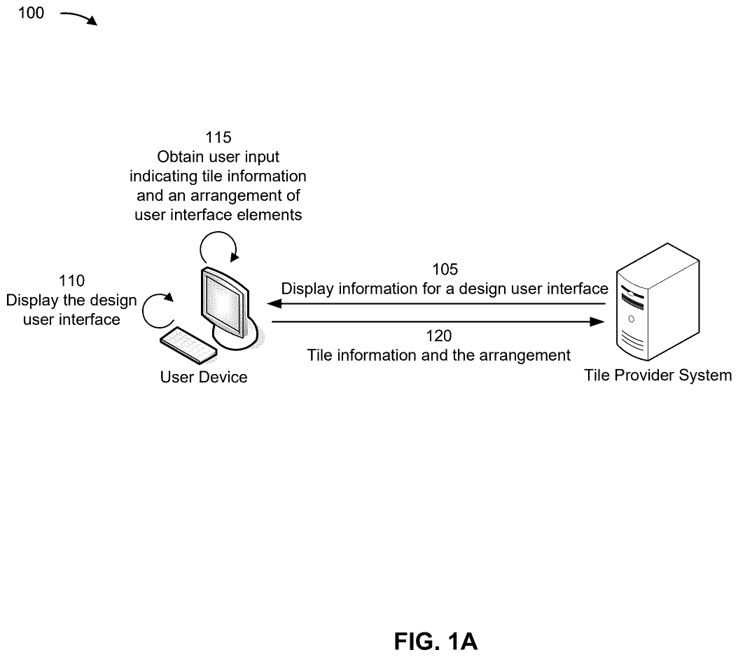

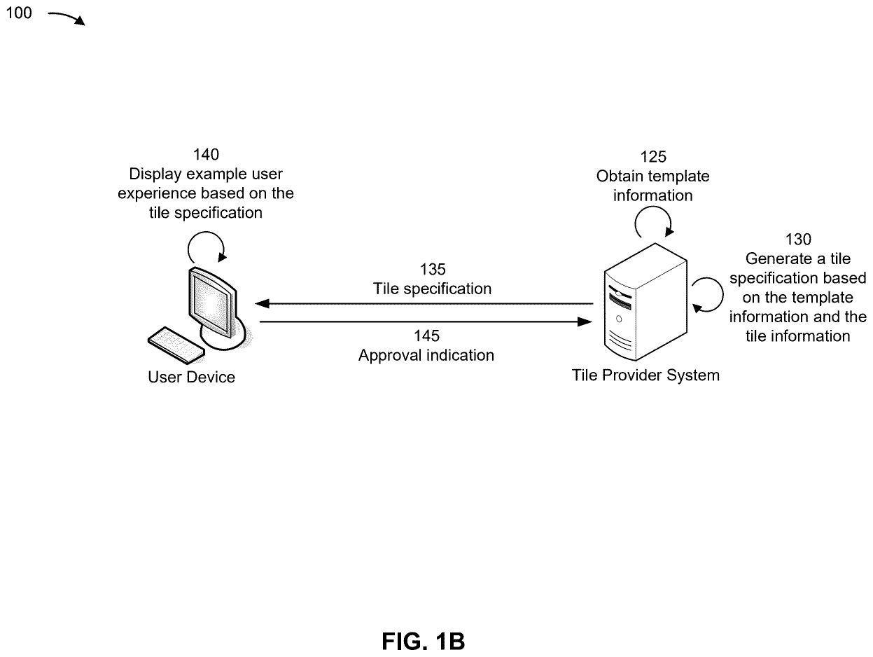

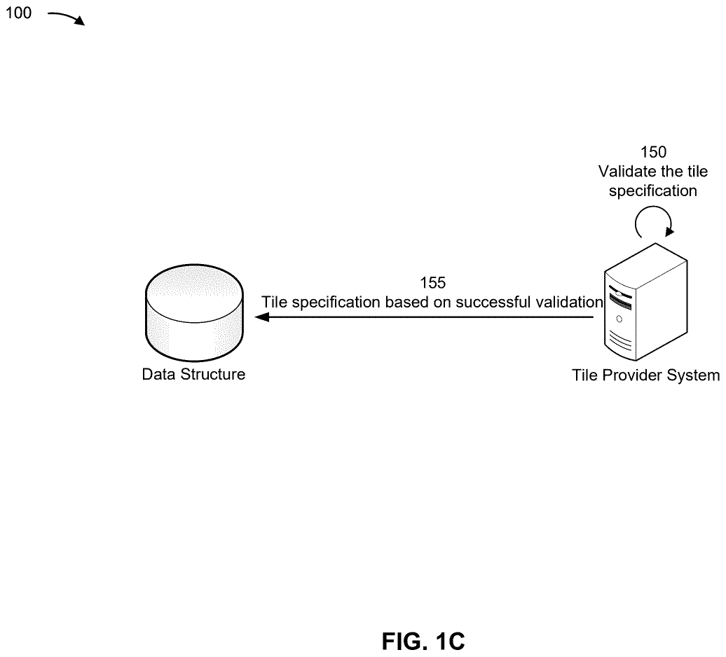

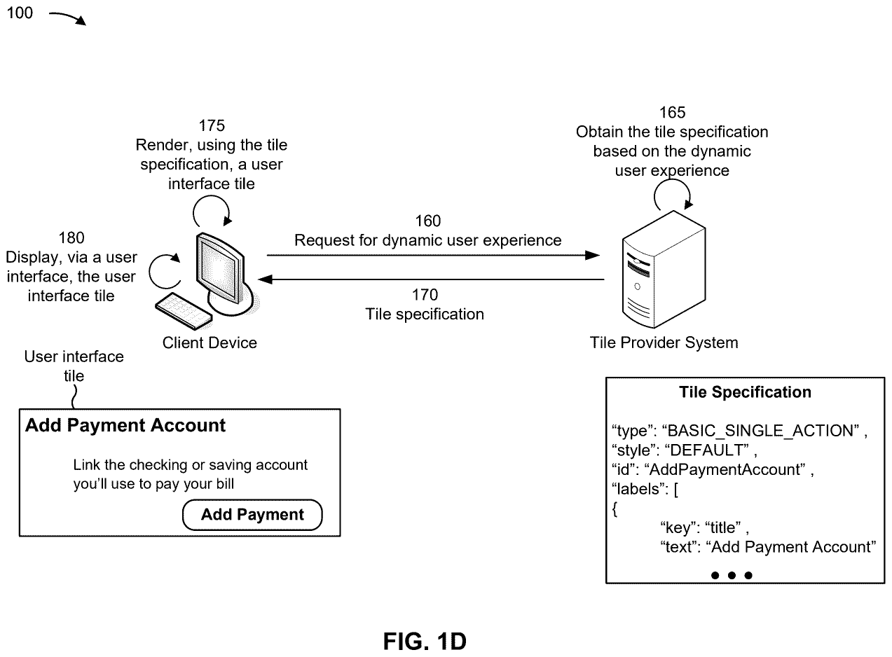

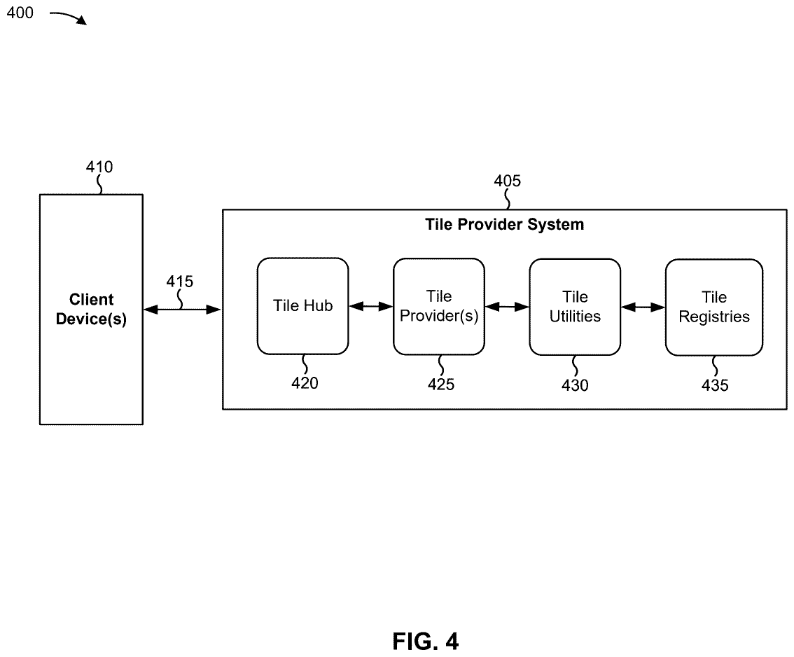

FIGS. 1A-1D are diagrams of an example 100 associated with tile specification generation for dynamic user interface tiles. As shown in FIGS. 1A-1D, example 100 includes a tile provider system, a user device, and a client device. These devices and systems are described in more detail in connection with FIGS. 4-6.

As shown in FIG. 1A, and by reference number 105, the tile provider system may transmit, and a user device may receive, display information for a design user interface. For example, the tile provider system may transmit the display information based on, or in response to, the user device requesting a resource (e.g., the design user interface) from the tile provider system. The display information may identify content for the design user interface that is to be provided for presentation by the user device. For example, the display information may identify content for a document object (e.g., a page requested by the user device) of the design user interface. The document object may be associated with a document object model (DOM) that includes code for generating the document object (e.g., the page).

As shown by reference number 110, the user device may display the design user interface. For example, the user device may display the design user interface based on the display information. The design user interface may include one or more pages configured to enable a user (e.g., a designer) to design a user experience and to cause one or more tile specifications to be created for the user experience. For example, the design user interface may include a first page configured to enable the user to select an arrangement of user interface elements. The first page may include one or more interactive user interface elements for respective arrangements of user interface elements. For example, the tile provider system may provide, for display via the design user interface, one or more interactive user interface elements. A selected arrangement of one or more user interface elements may be based on a user input to the design user interface associated with the one or more interactive user interface elements.

An arrangement of user interface elements may include a given quantity of user interface elements that can be configured to display content, images, and/or to enable actions to be performed when selected, among other examples. Additionally, an arrangement of user interface elements may include one or more user interface elements configured in a given arrangement or design within a user interface tile. An arrangement of user interface elements may indicate a location, position, orientation, and/or size, among other examples, of respective user interface elements in a user interface tile.

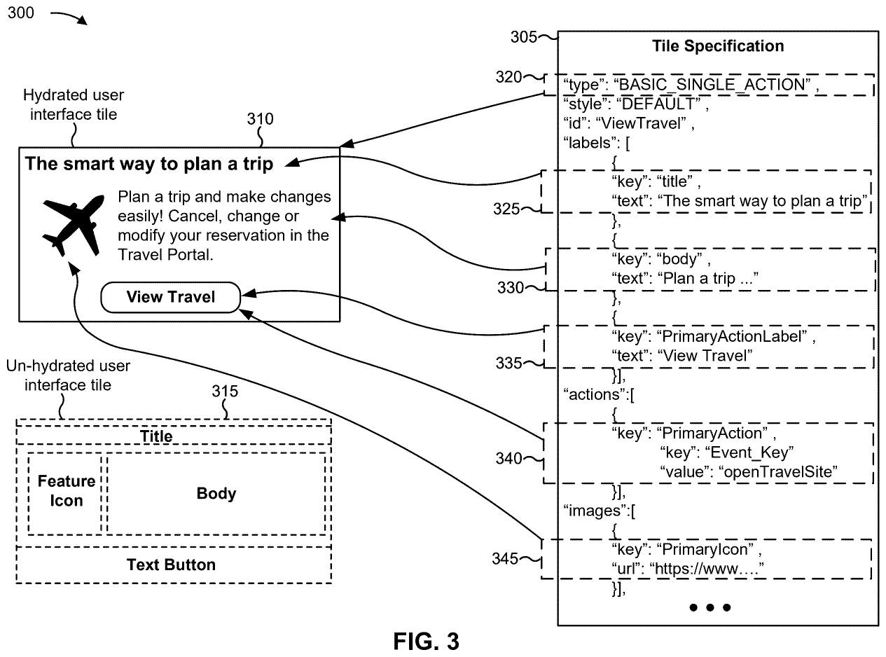

A user interface element may be a component that enables a user to interact with, or view information via, a user interface. For example, a user interface element may include a button, a text field, a check box, a title field, an action field, a body field, an icon, and/or an image, among other examples. For example, a user interface tile may include one or more user interface elements in an arrangement (e.g., as shown in more detail in connection with FIG. 3 where a title, feature icon, body, and text button are shown as example user interface elements).

For example, the display information may include multiple arrangements of user interface elements. The multiple arrangements of user interface elements may be based on previously created or designed user interfaces. In some examples, the multiple arrangements of user interface elements may be based on one or more prototype templates stored by the tile provider system and/or one or more tile types (e.g., as described in more detail in connection with FIG. 3). For example, a given prototype template may be mapped to, or otherwise associated with, a given arrangement of user interface elements. A prototype template may include information elements or fields that are modifiable (e.g., based on an input to the design user interface) to cause the one or more user interface elements (e.g., in the arrangement) to display certain content, certain images, and/or to cause certain actions to be performed when selected. In some examples, a prototype template may include one or more separate fields or information elements for each user interface element included in an arrangement. The information elements or fields in a prototype template may be ordered or configured based on the arrangement of user interface elements. For example, a given arrangement of user interface elements may be based on a previously created tile specification (e.g., where the previously created tile specification is configured to cause a user experience to be rendered in the given arrangement of user interface elements). The prototype template may include information elements or fields corresponding to one or more fields included in the previously created tile specification.

The design user interface may include a second page that is configured to enable the user to input tile information for one or more user interface elements in a selected arrangement. In some examples, the first page and the second page may be included in the same page (e.g., a single page) of the design user interface. In other examples, the first page and the second page may be included in separate pages of the design user interface. For example, the display information may be configured to cause the second page to include tile information fields for respective information elements or fields in a prototype template that is associated with a selected arrangement of user interface elements. A tile information field may enable the user to input or select content, one or more images, and/or one or more actions, among other examples, to be associated with a given user interface element in the selected arrangement of user interface element.

For example, the prototype template may include a first field associated with indicating content to be displayed in a given user interface element included in the arrangement. Based on the prototype template including the first field, the second page may include a first tile information field that is configured to enable the user to input the content that the user intends to be displayed in the given user interface element. As another example, the prototype template may include a second field associated with indicating an action to be performed when a given user interface element included in the arrangement is selected. Based on the prototype template including the second field, the second page may include a second tile information field that is configured to enable the user to input or select the action that the user intends to be performed when the given user interface element is selected. As another example, the prototype template may include a third field associated with indicating an image to be displayed in a given user interface element. Based on the prototype template including the third field, the second page may include a third tile information field that is configured to enable the user to input or select the image (e.g., to insert an indication of a location from which the image can be obtained, such as a uniform resource locator (URL)) to be displayed in the given user interface element. The second page may include a respective tile information field for each modifiable field or information element included in the prototype template associated with the selected arrangement of user interface elements.

As shown by reference number 115, the user device may obtain one or more user inputs indicating tile information and an arrangement of user interface tiles for a dynamic user experience. For example, the user device may obtain a user input indicating a selection of an arrangement of user interface elements (e.g., via the first page of the design user interface). The selection of the arrangement may cause the user device to display one or more tile information fields for the selected arrangement (e.g., as described above). The user device may obtain a user input indicating tile information for the dynamic user experience based on one or more inputs to one or more tile information fields. The tile information may be included in rendering information for the prototype template, as described in more detail below.

As an example, the tile information may include content to be displayed via a given user interface element, an indication of an image to be displayed via a given user interface element, and/or an indication of an action to be performed when a given user interface element is selected or interacted with, among other examples. In some examples, the tile information may include an identifier of the dynamic user experience (e.g., a name of the dynamic user experience). For example, the identifier may enable the dynamic user experience to be identified by the tile provider system (e.g., when requested by the client device, as described in more detail elsewhere herein). As shown by reference number 120, the user device may transmit, and the tile provider system may obtain, the tile information and an indication of a selected arrangement of user interface elements.

As shown in FIG. 1B, and by reference number 125, the tile provider system may obtain template information for tile specification generation. The template information may include one or more prototype templates for the arrangement of one or more user interface elements. For example, the tile provider system may obtain an indication of the arrangement of user interface elements selected by the user via the design user interface. The tile provider system may obtain, based on the arrangement, the one or more prototype templates. For example, the tile provider system may include one or more tile registries. A tile registry may include a prototype registry that includes prototype templates for respective arrangements of user interface elements. The tile provider system may search for and/or obtain the one or more prototype templates based on the arrangement indicated by the user device.

Additionally, or alternatively, the template information may include one or more specification templates. A specification template may be a template for a tile specification. In some examples, a specification template may be based on, or may include, one or more prototype templates. For example, a specification template may include one or more prototype templates that are arranged and/or ordered based on a given arrangement of use interface tiles. For example, the tile provider system may obtain a specification template based on the arrangement of tile elements indicated by the user device. Additionally, or alternatively, the tile information provided by the user device may indicate a tile type associated with the arrangement of tile elements. The tile provider system may obtain a specification template based on the tile type associated with the arrangement of tile elements.

As shown by reference number 130, the tile provider system may generate a tile specification based on the template information and the tile information. For example, the tile provider system may generate, based on the arrangement of user interface tiles (e.g., indicated by the tile information) and the one or more prototype templates, one or more tile specifications for the dynamic user experience.

For example, the tile provider system may obtain one or more specification templates based on the one or more user interface elements (e.g., based on the selected arrangement and/or selected tile type), as described above in connection with reference number 125. The tile provider system may populate rendering information in the one or more specification templates to generate the one or more tile specifications. The rendering information may be indicated by the one or more prototype templates and/or the tile information obtained via the user input to the design user interface. For example, the rendering information may include a data object that includes one or more key-value pairs and/or an ordered list (or array) of values that indicate an information set.

As an example, a prototype template may include a modifiable data object for indicating an image to be displayed via a given user interface element. The modifiable data object may include a key of “Primary Icon” and a modifiable value for indicating a source (e.g., a URL) from which an image to be shown via the given user interface element can be obtained or retrieved. The tile information (e.g., obtained from a user input to the design user interface) may indicate the source from which an image element can be obtained or retrieved (e.g., may indicate a URL associated with the image). The tile provider system may generate a portion of a tile specification (e.g., for indicating that the image is to be displayed via the given user interface element) by populating the source (e.g., the URL from the tile information) into the modifiable value to create a data object (e.g., written in specification code, such as JSON) that includes the key of “Primary Icon” and a value that indicates the source (e.g., the URL from the tile information) of the image.

As another example, a prototype template may include a modifiable data object for indicating text to be displayed via a given user interface element. The modifiable data object may include a key, such as “body” or “title” among other examples, and a modifiable value for indicating the text to be shown via the given user interface. The tile information (e.g., obtained from a user input to the design user interface) may indicate the text. The tile provider system may generate a portion of a tile specification (e.g., for indicating that the text is to be displayed via the given user interface element) by populating the text (e.g., obtained from the tile information) into the modifiable value to create a data object (e.g., written in specification code, such as JSON) that includes the key (e.g., “body” or “title”) and a value that indicates the text (e.g., from the tile information) to be displayed.

The tile provider system may generate one or more data objects and/or one or more ordered list (or arrays) of values for a tile specification in a similar manner. For example, the tile provider system may populate the information set shown via “labels” in FIG. 3 based on the tile information obtained via the design user interface. The tile provider system may populate identifying information for the tile specification based on the tile information. For example, the identifying information may include a style, and/or an identifier (e.g., a name of the dynamic user experience provided via a user input to the design user interface), among other examples. The generated tile specification(s) may be similar to be tile specification depicted and described in connection with FIG. 3.

As shown by reference number 135, the tile provider system may transmit or provide, and the user device may receive or obtain, a tile specification generated by the tile provider system (e.g., as described in connection with reference number 130). For example, the tile provider system may provide, to the user device, one or more tile specifications to cause a dynamic user experience to be displayed via the design user interface. For example, the tile provider system may provide the one or more tile specifications to enable the user device to provide a mockup display of the dynamic user experience that was designed via the design user interface. This enables the user (e.g., the designer) to view the dynamic user experience (e.g., as rendered in one or more channels or systems) to ensure that the generated tile specifications are causing a user interface tile to be rendered for the dynamic user experience as expected. This may conserve processing resources, network resources, and/or memory resources, among other examples, that would have otherwise been associated with the tile provider system storing a tile specification (e.g., that causes a user interface tile to be rendered for the dynamic user experience in an unintended or unexpected manner), the tile provider system providing the tile specification to a client device, the client device causing the user interface tile to be displayed, the client device providing feedback indicating that the user interface tile is rendered for the dynamic user experience in an unintended or unexpected manner, and/or the user device providing updated tile information to modify the tile specification, among other examples.

For example, as shown by reference number 140, the user device may display an example user experience based on the tile specification provided by the tile provider system. For example, the user device may obtain a user input indicating a channel for which the example user experience is to be displayed. For example, the channel may include an application (e.g., a web application or a mobile application), a web page, and/or a program, among other examples. Additionally, the channel may indicate a variant, such as an operating system (e.g., an application can be executed differently on different operating systems). The user device may render a user interface tile, based on the tile specification provided by the tile provider system, in accordance with the indicated channel to provide the example user experience for display. For example, the user device may render the user interface tile following one or more protocols or configurations that are used by the indicated channel to cause the user interface tile to be rendered as if the user device were displaying the user interface tile via the indicated channel.

In some examples, the tile provider system may provide or indicate example dynamic data to be used to render (and/or hydrate) the user interface tile based on the tile specification. This enables the user (e.g., the designer) to view the designed user experience as rendered in accordance with one or more channels. As a result, the user can quickly and easily determine if the tile specification was generated by the tile provider system in a manner that causes the designed user experience to be provided as expected via one or more channels. This enables the user to provide feedback and/or to cause the tile specification to be modified before the tile specification is added to a registry or database and/or before the tile specification is provided to one or more client devices, thereby conserving processing resources, network resources, and/or memory resources, among other examples. Additionally, this enables the user to view and/or modify the tile specification for the designed user experience without having to communicate or interface with a backend team.

In some examples, if the user (e.g., the designer) determines that the user experience is not being rendered as expected, then the user can provide an input to the design user interface to update the arrangement of user interface elements, the tile type for the user experience, and/or the tile information, among other examples (e.g., in a similar manner as described above). If the user (e.g., the designer) determines that the user experience is being rendered as expected, then the user device may obtain an approval indication via a user input to the design user interface. The approval indication may indicate that the dynamic user experience is to be registered and/or made available for one or more client devices. As shown by reference number 145, the user device may transmit or provide, and the tile provider system may receive or obtain, the approval indication. The approval indication may indicate that the tile provider system is to store the generated tile specification for the dynamic user experience.

As shown in FIG. 1C, and by reference number 150, the tile provider system may validate the tile specification. For example, the tile provider system may perform a validation operation using the tile specification to determine whether the tile specification is valid for use. In some examples, the validation operation may be based on one or more client capabilities and/or one or more system capabilities.

For example, the tile provider system may store capability information for one or more client devices. The capability information may indicate one or more client capabilities supported by a client device for dynamic user interface tiles (e.g., for the dynamic user experience and/or for other dynamic user experiences). In some implementations, the capability information may include an indication of a tile specification schema supported by the client device. For example, the client device may be configured to interpret and/or decode tile specifications, as described elsewhere herein. The capability information may indicate a version of the schema or format of the tile specifications that the client device is capable of interpreting and/or decoding. The capability information may include tile capability information. The tile capability information may include one or more client capabilities associated with content and/or actions to be associated with user interface tiles, as described herein. For example, the capability information may include one or more user interface actions supported by the application. The one or more user interface actions may be action types supported by the application and/or the client device. A user interface action may be an action that the client device (and/or application) is configured to perform based on a user interaction with a user interface element displayed via a user interface tile. In some implementations, the capability information may include one or more image schema supported by the application and/or the client device. For example, an image schema may include a format for indicating a source of an image to be included in a user interface tile, such as a URL format (e.g., a hypertext transfer protocol secure (HTTPS) format), a local data source format, and/or another format.

In some implementations, the capability information may include one or more user interface events supported by the application and/or the client device. A user interface event may be associated with a user interface action that is to be performed locally on the client device. In some implementations, the capability information may include one or more markup types supported by the application and/or client device. The one or more markup types may include an action type, a bold type, an italics type, a list item type, and/or a phone type, among other examples. The capability information may include one or more supported tile elements associated with a tile specification. A tile element may be a visual and/or graphical element included in a user interface tile. For example, the capability information may indicate one or more types of user interface elements (e.g., tile elements) that the application and/or client device can render. In some implementations, the capability information may include one or more supported tile types.

In some implementations, the tile provider system may support one or more system capabilities. The one or more system capabilities may be similar to the one or more client capabilities. For example, the one or more provider capabilities may indicate capabilities for similar information or actions as described above in connection with the capability information.

The tile provider system may perform the validation operation by determining whether the tile specification can be rendered, interpreted, decoded, and/or is otherwise supported by the one or more client capabilities and/or the one or more system capabilities. For example, the one or more system capabilities may indicate that the tile provider system only supports certain formats, certain user interface actions, and/or certain user interface elements (e.g., tile elements) for a given dynamic user experience, a given user interface tile, and/or a given tile type. If the tile specification includes a format, user interface action, and/or user interface element that is not supported by the tile provider system, then the tile provider system may determine that the tile specification is not valid for use. If the tile specification uses a format, indicates one or more user interface actions, and/or is associated with one or more user interface elements, among other examples, that are supported by the tile provider system, then the tile provider system may determine that the tile specification is valid for use.

As another example, if the one or more client capabilities indicate that one or more clients do not support the tile specification (e.g., do not support a format, one or more user interface actions, and/or one or more user interface elements, among other examples, associated with the tile specification), then the tile provider system may determine that the tile specification is not valid for use (e.g., for the one or more clients). As another example, if the one or more client capabilities indicate that one or more clients do support the tile specification (e.g., do support a format, one or more user interface actions, and/or one or more user interface elements, among other examples, associated with the tile specification), then the tile provider system may determine that the tile specification is valid for use (e.g., for the one or more clients).

If the capability information indicates that the tile specification is not valid for use, then the tile provider system may perform one or more actions. In some implementations, the one or more actions may include the tile provider system transmitting, and the user device receiving, an indication indicating that the tile provider system is unable to provide the dynamic user experience as designed. In some implementations, the indication may include an indication that one or more clients and/or the tile provider system does not support minimum capabilities for the dynamic user experience as designed. This enables the user (e.g., the designer) to update or modify the design of the dynamic user experience (e.g., via the design user interface in a similar manner as described above) so that the dynamic user experience can be provided by the tile provider system and/or can be rendered or provided by one or more client devices.

In some other implementations, the one or more actions may include the tile provider system selecting an alternate component (e.g., an alternate user interface tile, an alternate tile specification, and/or an alternate user interface element) that is supported by the one or more clients and/or the tile provider system. For example, the tile provider system may substitute the component for the dynamic user experience that is not supported with a substitute component that is supported by the client(s) and/or the tile provider system. The substitute component may be associated with the same purpose, goal, or action as the original component that is not supported. This enables the tile provider system to handle situations where the client(s) and/or the tile provider system do not support the minimum capabilities for the dynamic user experience without interruption.

Alternatively, if the tile provider system determines that the tile specification is valid, then the tile provider system may register the dynamic user experience for use. For example, as shown by reference number 155, the tile provider system may store the tile specification in the data structure in association with the dynamic user experience. The tile provider system may store the one or more tile specifications in the data structure based on the validation operation indicating that the one or more tile specifications are valid for use. This conserves memory resources that would have otherwise been associated with the tile provider system storing a tile specification that is not valid for use by the tile provider system and/or by one or more clients.

The tile specification may be stored with an identifier or name of the dynamic user experience. This enables the tile provider system to obtain or retrieve the tile specification when the dynamic user experience is requested by a client device (e.g., by searching the data structure using the identifier or name of the dynamic user experience). The data structure is included in an experience registration database for the tile provider system. In some implementations, the data structure may be included in a tile registry, such as a tile registry depicted and described in connection with FIG. 4. By the tile provider system storing the tile specification in the data structure, the tile provider system may make the dynamic user experience available for use for one or more client devices. The tile provider system may store one or more tile specifications for the dynamic user experience in a similar manner as described above.

As shown in FIG. 1D, the client device may detect that a dynamic user experience is to be provided (e.g., displayed) via a user interface (e.g., a GUI). For example, the client device may detect that a user has navigated to a page, and/or interacted with a graphical element of the user interface, among other examples, that is configured to cause the client device to provide the dynamic user interface. Additionally, or alternatively, the client device may detect or determine that the user interface has been opened via the client device.

As shown by reference number 160, the client device may transmit, and the tile provider system may receive, a request (e.g., a client request) for the dynamic user experience associated with the user interface. For example, the client device may determine the dynamic user experience based on user interaction with the user interface. The client device may determine the dynamic user experience based on the user interface, the page, and/or other information to be displayed via the user interface. The request for the dynamic user experience may include an identifier of the dynamic user experience.

As shown by reference number 165, the tile provider system may obtain or retrieve the tile specification from the data structure based on the client request. For example, the tile provider system may search for the tile specification in the data structure using the identifier of the dynamic user experience. As shown by reference number 170, the tile provider system may transmit, and the client device may receive, the tile specification. The tile specification may indicate user interface information for a user interface tile associated with the dynamic user experience (e.g., requested by the client device as described in connection with reference number 160). As described in more detail elsewhere herein, the specification may be a data object that indicates user interface information in a channel agnostic manner. The structure and/or content of the tile specification is depicted and described in more detail in connection with FIG. 3.

As shown by reference number 175, the client device may render, using the tile specification, a user interface tile. For example, the client device may render one or more user interface elements associated with the user interface tile based on the tile specification. For example, the client device may interpret and/or decode the tile specification to obtain (e.g., extract) the user interface information. The client device may use a rendering engine (e.g., of the client device and/or an application executing on the client device) to process the user interface information and translate the user interface information into visual components (e.g., native components) of a user interface framework that the client device is configured to use. The client device may render the user interface tile (e.g., using the user interface information obtained from the tile specification) in accordance with the rendering engine, operating system, and/or user interface framework that is used by the client device and/or the application. For example, the client device may obtain information for user interface templates and/or user interface actions (e.g., indicated by the tile specification) from local libraries (e.g., stored by the client device and/or accessible by the client device), as described in more detail elsewhere herein (such as in connection with FIG. 4). This reduces the complexity and increases the flexibility for modifying and/or updating user experiences provided by the user interface because the client device (and/or the application) can use the rendering engine and/or visual components (e.g., native components) of the user interface framework of the client device (and/or the application).

As shown by reference number 180, the client device may display, via a client user interface (e.g., a second user interface), the user interface tile. For example, the client device may provide the one or more user interface elements of the user interface tile for display via the client user interface.

As indicated above, FIGS. 1A-1D are provided as an example. Other examples may differ from what is described with regard to FIGS. 1A-1D.

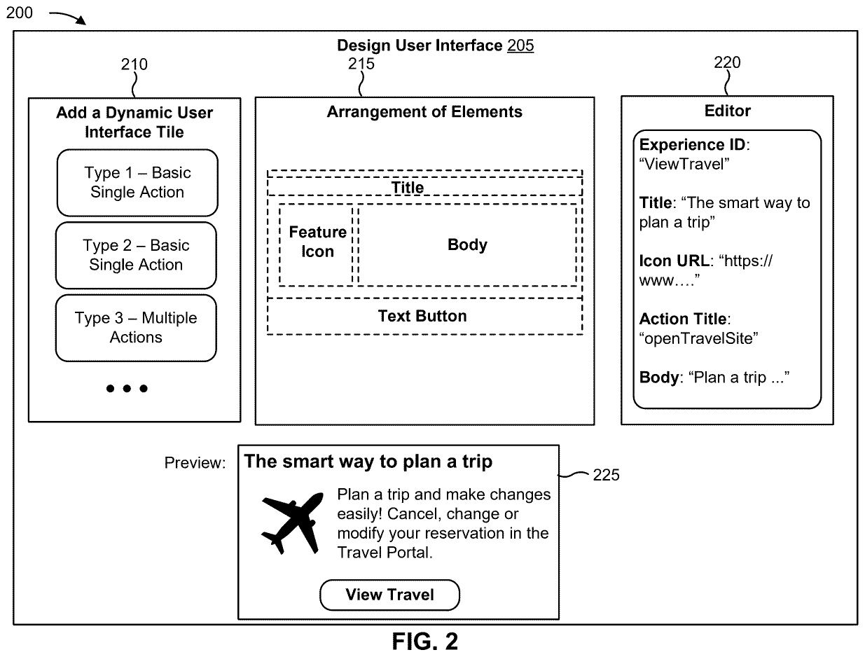

FIG. 2 is a diagram of an example 200 associated with a design user interface 205 for tile specification generation for dynamic user interface tiles.

As described elsewhere herein, such as in connection with FIGS. 1A-1D, the design user interface 205 may be used by a user to design or configure a dynamic user experience. The design user interface 205 may include one or more pages. For example, a first page 210 may be associated with a selection of a tile type for the dynamic user experience. For example, a user device may receive display information that indicates one or more tilt types supported by the tile provider system. A tile type may be associated with an arrangement of user interface elements. In some examples, a given tile type may be associated with multiple arrangements of user interface elements. For example, the first page 210 may include one or more interactive user interface elements that enable a user to select a tile type.

As shown in FIG. 2, a second page 215 may display an arrangement of user interface elements for a selected tile type. The arrangement and/or tile type may be associated with one or more prototype templates and/or specification templates, as described in more detail elsewhere herein. A third page 220 may display one or more fields for inputting tile information for the selected tile type and/or the selected arrangement of user interface elements. For example, the third page 220 may enable a user to edit content, images, and/or actions associated with respective user interface elements to design the dynamic user experience. In some implementations, the second page 215 may include one or more interactive user interface elements that enable a user to modify the arrangement of user interface elements for the selected tile type (or to select an arrangement from multiple arrangements).

As an example, the selected arrangement (shown via the second page 215) may include one or more user interface elements, such as a title element, a feature icon element, a body element, and a text button element. The third page 220 may include fields corresponding to the respective user interface elements of the one or more user interface elements. For example, the one or more prototype templates and/or specification templates associated with the arrangement and/or tile type may indicate modifiable fields or data objects. The third page 220 may include at least one field for each modifiable field or data object included in the one or more prototype templates and/or specification templates. The one or more fields included in the third page 220 may enable a user to input tile information for the dynamic user interface tile associated with the dynamic user experience.

For example, as shown in FIG. 2, the third page 220 includes a title field via which a user can input text to be displayed in the title element (e.g., shown as “The smart way to plan a trip” in FIG. 2). As another example, the third page 220 may include an icon URL field via which the user can input a source for an image to be displayed via the feature icon element. As another example, the third page 220 may include an action title field via which the user can input an action to be performed when the user selects the text button element (e.g., shown in FIG. 2 as “openTravelSite which may be indicative of a travel website or page to be opened when a user selected the text button element) and/or text to be displayed via the text button element. The third page 220 may include a body field via which the user can input text to be displayed in the body element. The third page 220 may include an identifier field via which the user can input an identifier of the name of the dynamic user experience (e.g., shown as “ViewTravel” in FIG. 2).

As described in more detail elsewhere herein, the tile provider system may generate one or more tile specifications based on the selected tile type, the selected arrangement of user interface elements, and/or the tile information input via the one or more fields of the third page 220. The tile provider system may provide the generated tile specification(s) to the user device to enable the user device to display an example user interface tile 225 for the dynamic user experience. For example, the design user interface 205 may include an element or page via which a preview of the dynamic user experience is displayed. The preview may include the example user interface tile 225 that is based on the generated tile specification(s). For example, the user device may render the example user interface tile 225 based on the generated tile specification(s) and in accordance with a channel (e.g., that may be selected or indicated via a user input to the design user interface 205).

In some examples, the design user interface 205 may include a field to enable the user to approve the dynamic user experience. For example, the user may view the example user interface tile 225 and/or other example user interface tiles (e.g., that are rendered in accordance with other channels) to determine whether the dynamic user experience is being provided as expected or intended (e.g., where the example user interface tile(s) are provided based on the generated tile specification(s)). If the user determines that the dynamic user experience is being provided as expected or intended, then the user can approve the dynamic user experience to cause the one or more tile specifications to be registered and/or stored by the tile provider system. If the user determines that the dynamic user experience is not being provided as expected or intended, then the user can modify information input and/or selected via the design user interface 205.

As indicated above, FIG. 2 is provided as an example. Other examples may differ from what is described with regard to FIG. 2.

FIG. 3 is a diagram of an example 300 associated with a tile specification 305 for dynamic user interface tiles. As described elsewhere herein, the tile specification 305 may include information (e.g., code and/or instructions) that enables a client device (e.g., the client device described in connection with FIGS. 1A-1D and 2 and/or elsewhere herein) to render a user interface tile 310 (e.g., shown in FIG. 3 as a hydrated user interface tile). As used herein, a “hydrated” user interface tile refers to a user interface tile with inserted data or information (e.g., as indicated by the tile specification 305).

For example, a user interface tile template 315 may define a template for a type 320 of user interface tile. The user interface tile template 315 may be an un-hydrated user interface tile (e.g., a user interface tile without data or information inserted). For example, the user interface tile template 315 may define a generic template for the type 320 of user interface tile. As shown in FIG. 3, the user interface tile template 315 may indicate a location, position, orientation, and/or size for one or more fields. As shown in FIG. 3, the one or more fields may include a title, a feature icon, a label, and/or a text button, among other examples. The one or more fields may correspond to user interface elements of the user interface tile 310.

The tile specification 305 may be an information set that defines how to render the user interface tile 310 and/or what information is to be included in the user interface tile 310. The tile specification 305 may be a data object that includes one or more key-value pairs and/or an ordered list (or array) of values that indicate the information set. In some implementations, the tile specification 305 may use code, such as JSON code, to indicate the information set. For example, the tile specification 305 may be a JSON object, a JSON payload, and/or a JSON document.

The tile specification 305 may indicate the type 320 of the user interface tile 310. The type 320 may indicate that the user interface tile template 315 is to be used to render the user interface tile 310. For example, the type 320 may enable the client device to identify the user interface tile template 315 that is to be used to render the user interface tile 310. The user interface tile template 315 may define or indicate one or more native components (e.g., the one or more fields) to be used by the client device to render the user interface tile 310. The type 320 of the user interface tile 310 may be a basic single action tile (e.g., a user interface tile configured or designed to enable a user to perform a basic single action, such as navigate to a travel website as shown in FIG. 3). Other types of user interface tiles may be defined or configured (e.g., for performing other actions or displaying other types of content) in a similar manner, such as by using other user interface tile templates.

The tile specification 305 may include one or more labels (e.g., key-value pairs) for indicating information to be included in the user interface tile 310 and/or actions to be provided by the user interface tile 310. The one or more labels may indicate user interface information for the user interface tile 310. The one or more labels may indicate information and/or elements to be inserted into the one or more fields of the user interface tile template 315. For example, the one or more labels may define text content to be displayed via the user interface tile 310. An image element in the tile specification 305 may define image content to be displayed.

As shown in FIG. 3, the one or more labels may include a title 325. The title 325 may indicate information to be inserted into a title field of the user interface tile template 315. For example, a key value may indicate that the information is associated with the title 325 and text value may indicate the text to be inserted into the title field (e.g., “The smart way to plan a trip” as shown in FIG. 3). The one or more labels may include a body 330. The body 330 may indicate information to be inserted into the body of the user interface tile template 315, such as the label field shown in FIG. 3. For example, a key value may indicate that the information is associated with the body 330 and text value may indicate the text to be inserted into the label field shown in FIG. 3.

The one or more labels may include an action label 335. The action label 335 may indicate information (e.g., text) to be used as a label for an interactive user interface element that is configured to enable the user to perform an action. For example, as described above, the type 320 may be associated with a single action. The user interface tile template 315 may include a field associated with an interactive user interface element that, when interacted with by a user, causes the client device to perform an action. For example, the field associated with an interactive user interface element is shown in FIG. 3 as the text button field. The action label 335 may indicate a label for the interactive user interface element to be included in the user interface tile 310. For example, a key value may indicate that the information is associated with the action label 335 and text value may indicate the text to be inserted as the label (e.g., “View Travel” as shown in FIG. 3). An action element may define the behavior that should be performed when a user interacts (e.g., selects) the interactive user interface element.

The tile specification 305 may indicate one or more actions 340 to be enabled by the user interface tile 310. For example, the one or more actions 340 may be one or more actions to be performed by the client device based on a user interacting with an interactive user interface element of the user interface tile 310. For example, the one or more actions 340 may indicate what the client device is to do based on (e.g., when or after) detecting that a user has interacted with an interactive user interface element of the user interface tile 310. In some implementations, such as when the type 320 is associated with multiple actions, the one or more actions 340 may indicate which interactive user interface elements respective actions of the multiple actions are to be associated with. As an example, the one or more actions 340 indicated by the tile specification 305 may include navigating to a travel website or page (e.g., the travel website or page may be indicated by the value “openTravelSite” as shown in FIG. 3). The client device may configure the user interface tile 310 such that the client device navigates to the indicated travel website or page based on a user interacting with (e.g., clicking, selecting, or touching) the interactive user element (e.g., shown with the action label 335 of “View Travel” in FIG. 3).

The tile specification 305 may indicate image content to be displayed via the user interface tile 310. For example, the tile specification 305 may indicate an icon 345 to be displayed via the user interface tile 310. The tile specification 305 may indicate a source from which the image content can be obtained or retrieved. For example, as shown in FIG. 3, the tile specification 305 may indicate a URL from which the icon 345 shown in the user interface tile 310 can be obtained or retrieved.

The tile specification 305 shown in FIG. 3 is provided as an example. In other examples, a tile specification may indicate different labels, a different quantity of labels, a different type 320, different action(s) 340, and/or a different quantity of actions 340, among other examples. Additionally, the tile specification 305 may define image content, questions, and/or options, among other examples, to be displayed via the user interface tile 310. The tile specification 305 may enable the user interface tile template 315 to be reused for different user experiences. For example, by the tile provider system changing information indicated by the tile specification 305 for the type 320, the user interface tile template 315 can be used by the client device to render user interface tiles for different user experiences. Additionally, the tile provider system can dynamically update a user experience by changing information indicated by the tile specification 305 for the type 320, thereby enabling the client device to render the user interface tile 310 based on the changed information and the user interface tile template 315. This reduces the complexity associated with updating or changing user experiences by the tile provider system defining or configuring the user experiences in a channel-agnostic manner using the tile specification 305.

As indicated above, FIG. 3 is provided as an example. Other examples may differ from what is described with regard to FIG. 3.

FIG. 4 is a diagram of an example 400 associated with a tile provider system 405 for dynamic user interface tiles. The tile provider system 405 may communicate the one or more client devices 410 via a communication interface 415. The tile provider system 405 may be, or may be similar to, the tile provider system described in connection with FIGS. 1A-1C and 3. Similarly, the one or more client devices 410 may be, or may be similar to, the client device described in connection with FIGS. 1A-1D, 2, and 3.

The one or more communication interfaces 415 may include a wireless connection and/or a wired connection. In some implementations, the one or more communication interfaces 415 may include one or more APIs, a transmission control protocol (TCP) interface, a message queue interface, a remote procedure call interface, a simple mail transfer protocol (SMTP) interface, a simple object access protocol (SOAP) interface, and/or an Internet protocol (IP) interface, among other examples. For example, the tile provider system 405 and the one or more client devices 410 may be configured to communicate one or more tile specifications, and/or capability information, among other examples, via the one or more communication interfaces 415.

The client device(s) 410 may include a rendering component (e.g., an engine) configured to interpret and/or decode tile specifications and render user interface tiles. The engine may include a plugin or module configured for interpreting and/or decoding tile specifications, such as the tile specification 305. The client device(s) 410 may include, or be configured to access, one or more libraries. For example, the one or more libraries may include a tile type library, and/or an action library, among other examples. A tile type library may include user interface tile templates (such as the user interface tile template 315) for respective types (such as the type 320) of user interface tiles. An action library may include information for different types of actions to be performed by the client device(s) 410, such as the one or more actions 340. The one or more libraries may include information that is specific to a channel, a framework (e.g., a coding framework), and/or ecosystem, among other examples in which a given client device 410 is configured to operate. This enables the client device 410 to obtain the information (e.g., that is specific to a channel, a framework (e.g., a coding framework), and/or ecosystem) as part of interpreting and/or decoding tile specifications, thereby enabling the client device to render the user interface tiles (e.g., as defined by the tile specification(s)) in accordance with the channel, a framework (e.g., a coding framework), and/or ecosystem examples in which the given client device 410 is configured to operate.

As shown in FIG. 4, the tile provider system 405 may include one or more components, such as a tile hub component 420 (e.g., which may be, or include, a routing component), one or more tile provider components 425, one or more tile utility components 430 (e.g., a tile resolver and/or a tile hydrator), and/or one or more tile registries 435, among other examples. The tile hub component 420 may be configured to route requests for user experiences to a given tile provider component 425. For example, the tile hub component 420 may be a routing component that is configured to route requests for user experiences based on a type of user experience, and/or a client device 410 that transmitted the request(s), among other examples. For example, one or more tile provider components 425 may include a generic tile provider component and/or one or more service tile provider components. The one or more service tile provider components may be configured to generate tile specifications for respective services or respective user experiences (e.g., a service tile provider may be specific to a given user experience). The generic tile provider component may be configured to generate tile specifications for all other user experiences (e.g., that are not associated with service tile provider components).

For example, a tile provider component 425 may be configured to obtain data from one or more data sources to be included in a tile specification. The tile provider component 425 may be configured to transmit, to one or more data sources, a request for data associated with a client device 410 (e.g., associated with an account or user that is associated with the client device 410) that transmitted a request for a user experience. The tile provider component 425 may be configured to receive, from the one or more data sources, the data (sometimes referred to herein as “dynamic” data). The tile provider component 425 may be configured to communicate with the one or more tile utility components 430 to generate the tile specification(s).

For example, the one or more tile utility components 430 may include a resolver component and a hydrator component. The resolver component may be configured to identify one or more tile specifications and/or one or more user interface tile templates 315 for an indicated user experience. For example, the tile provider component 425 may transmit, and the resolver component may receive, an indication of the user experience requested by a client device 410. The resolver component may identify (e.g., from the one or more tile registries 435) one or more tile specifications and/or one or more user interface tile templates 315 for the user experience. The one or more tile registries 435 may store tile specifications, configurations, capability information, among other examples, for various user experiences. In some examples, the one or more tile registries 435 may include an experience registration database in which one or more tile specifications for a given dynamic user experience are stored.

The hydrator component may be configured to insert information into one or more tile specifications. For example, the one or more tile specifications and/or one or more user interface tile templates 315 obtained by the resolver component may include one or more placeholder fields to be replaced with data (e.g., the dynamic data for the client device 410) to generate a tile specification that can be used by the client device 410 for rendering one or more user interface tiles. For example, the tile provider component 425 may transmit, and the hydrator component may receive, an indication of the one or more tile specifications and the data that was obtained by the tile provider component 425 (e.g., the dynamic data for the client device 410). The hydrator component may insert the data into the one or more tile specifications to generate one or more tile specifications that are ready for rendering by the client device 410. The hydrator component may transmit, and the tile provider component 425 may receive, the one or more tile specifications (e.g., hydrated tile specification(s)). The tile provider component 425 may cause the one or more tile specifications to be transmitted to the client device 410 (e.g., via the tile hub component 420). For example, the tile provider system 405 may transmit, and the client device 410 may receive, the one or more tile specifications (e.g., hydrated tile specification(s)) via the communication interface 415.

The client device 410 may render one or more user interface tiles based on the one or more tile specifications and the libraries described above. For example, the engine of the client device may be configured to render the one or more user interface tiles based on the one or more tile specifications and the libraries. The client device 410 may display the one or more user interface tiles via a user interface (e.g., a GUI).

As indicated above, FIG. 4 is provided as an example. Other examples may differ from what is described with regard to FIG. 4.

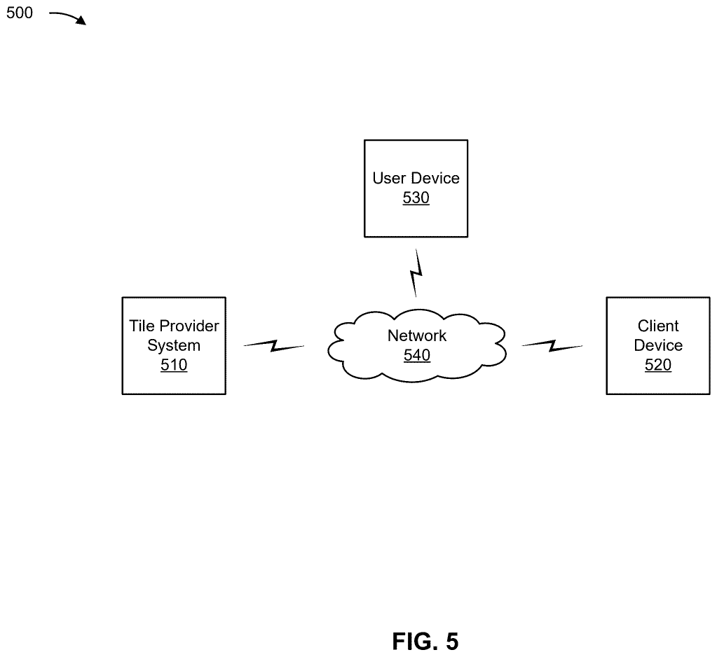

FIG. 5 is a diagram of an example environment 500 in which systems and/or methods described herein may be implemented. As shown in FIG. 5, environment 500 may include a tile provider system 510 (e.g., the tile provider system 405), a client device 520 (e.g., the client device 410), a user device 530, and a network 540. Devices of environment 500 may interconnect via wired connections, wireless connections, or a combination of wired and wireless connections.

The tile provider system 510 may include one or more devices capable of receiving, generating, storing, processing, providing, and/or routing information associated with tile specification generation for dynamic user interface tiles, as described elsewhere herein. The tile provider system 510 may include a communication device and/or a computing device. For example, the tile provider system 510 may include a server, such as an application server, a client server, a web server, a database server, a host server, a proxy server, a virtual server (e.g., executing on computing hardware), a server in a cloud computing system, and/or a serverless component in a cloud computing system (e.g., one or more serverless functions). In some implementations, the tile provider system 510 may include computing hardware used in a cloud computing environment.

The client device 520 may include one or more devices capable of receiving, generating, storing, processing, and/or providing information associated with tile specification generation for dynamic user interface tiles, as described elsewhere herein. The client device 520 may include a communication device and/or a computing device. For example, the client device 520 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The user device 530 may include one or more devices capable of receiving, generating, storing, processing, and/or providing information associated with tile specification generation for dynamic user interface tiles, as described elsewhere herein. The user device 530 may include a communication device and/or a computing device. For example, the user device 530 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 540 may include one or more wired and/or wireless networks. For example, the network 540 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 540 enables communication among the devices of environment 500.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

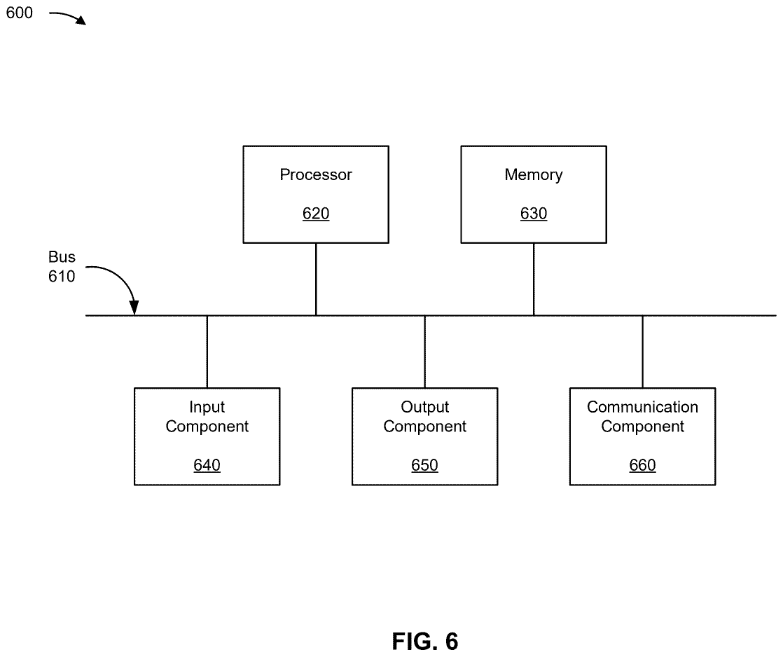

FIG. 6 is a diagram of example components of a device 600 associated with tile specification generation for dynamic user interface tiles. The device 600 may correspond to a tile provider system (e.g., the tile provider system 405 and/or the tile provider system 510), a client device (e.g., the client device 410 and/or the client device 520), a user device (e.g., the user device 530), the tile hub component 420, the tile provider component 425, a tile utility component 430, and/or a tile registry component 435. In some implementations, the tile provider system (e.g., the tile provider system 405 and/or the tile provider system 510), the client device (e.g., the client device 410 and/or the client device 520), the user device (e.g., the user device 530), the tile hub component 420, the tile provider component 425, the tile utility component 430, and/or the tile registry component 435 may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

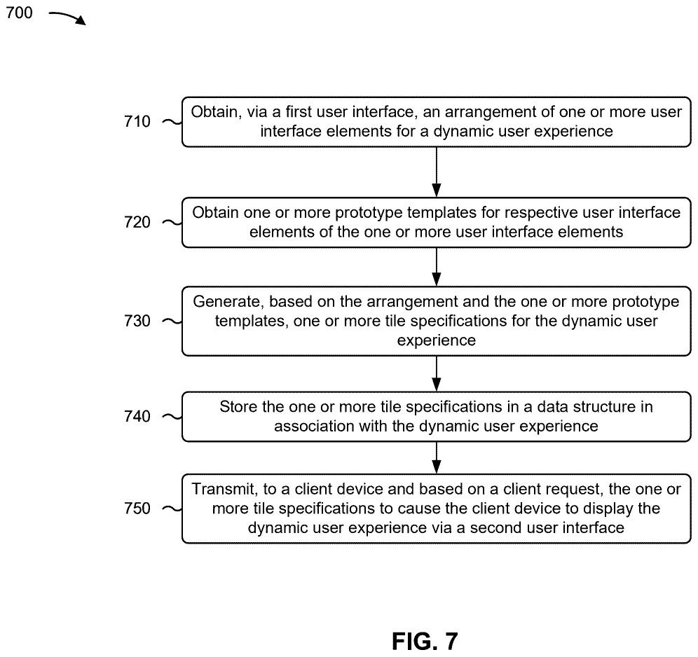

FIG. 7 is a flowchart of an example process 700 associated with tile specification generation for dynamic user interface tiles. In some implementations, one or more process blocks of FIG. 7 may be performed by a tile provider system (e.g., the tile provider system 405 and/or the tile provider system 510). In some implementations, one or more process blocks of FIG. 7 may be performed by another device or a group of devices separate from or including the tile provider system, such as a client device (e.g., the client device 410 and/or the client device 520), a user device (e.g., the user device 530), and/or a component of the tile provider system. Additionally, or alternatively, one or more process blocks of FIG. 7 may be performed by one or more components of the device 600, such as processor 620, memory 630, input component 640, output component 650, and/or communication component 660.

As shown in FIG. 7, process 700 may include obtaining, via a first user interface, an arrangement of one or more user interface elements for a dynamic user experience (block 710). For example, the tile provider system (e.g., using processor 620 and/or memory 630) may obtain, via a first user interface, an arrangement of one or more user interface elements for a dynamic user experience, as described above in connection with reference number 120 of FIG. 1A. As an example, the first user interface may be a design user interface (e.g., the design user interface 205). The arrangement of one or more user interface elements may be indicated by a tile type and/or a selection provided via the design user interface. In some examples, the tile provider system may obtain tile information for the dynamic user experience.

As further shown in FIG. 7, process 700 may include obtaining one or more prototype templates for the arrangement of one or more user interface elements (block 720). For example, the tile provider system (e.g., using processor 620 and/or memory 630) may obtain one or more prototype templates for the arrangement of one or more user interface elements, as described above in connection with reference number 125 of FIG. 1B. In some implementations, the one or more prototype templates include rendering information for a second user interface. As an example, the one or more prototype templates may be based on the arrangement and/or tile type indicated via the design user interface. The one or more prototype templates may be included in, or be associated with, one or more specification templates. The rendering information may include modifiable fields or data objects via which the tile information can be input.

As further shown in FIG. 7, process 700 may include generating, based on the arrangement and the one or more prototype templates, one or more tile specifications for the dynamic user experience (block 730). For example, the tile provider system (e.g., using processor 620 and/or memory 630) may generate, based on the arrangement and the one or more prototype templates, one or more tile specifications for the dynamic user experience, as described above in connection with reference number 130 of FIG. 1B. As an example, the tile provider system may populate the modifiable fields or data objects with the tile information provided via the design user interface to generate the one or more tile specifications.

As further shown in FIG. 7, process 700 may include storing the one or more tile specifications in a data structure in association with the dynamic user experience (block 740). For example, the tile provider system (e.g., using processor 620 and/or memory 630) may store the one or more tile specifications in a data structure in association with the dynamic user experience, as described above in connection with reference number 155 of FIG. 1C. As an example, the tile provider system may store the one or more tile specifications based on obtaining an approval indication that is input via the design user interface. Additionally, or alternatively, the tile provider system may store the one or more tile specification based on performing a successful validation operation for the one or more tile specifications, as described above in connection with reference number 150 of FIG. 1C.

As further shown in FIG. 700, process 700 may include transmitting, to a client device and based on a client request, the one or more tile specifications to cause the client device to display the dynamic user experience via a second user interface (block 750). For example, the tile provider system (e.g., using processor 620, memory 630, output component 650, and/or communication component 660) may transmit, to a client device and based on a client request, the one or more tile specifications to cause the client device to display the dynamic user experience via a second user interface, as described above in connection with reference number 170 of FIG. 1D. As an example, the client request may include an identifier of the dynamic user experience. The tile provider system may obtain the one or more tile specifications from the data structure based on the identifier. The one or more tile specifications may enable the client device to extract user interface information to locally render one or more user interface tiles for the dynamic user experience.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1A-1D and 2. Moreover, while the process 700 has been described in relation to the devices and components of the preceding figures, the process 700 can be performed using alternative, additional, or fewer devices and/or components. Thus, the process 700 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for tile specification generation for dynamic user interface tiles, the system comprising:
one or more memories; and
one or more processors, communicatively coupled to the one or more memories, configured to:
obtain, via a first user interface, an arrangement of one or more user interface elements for a dynamic user experience;
obtain one or more prototype templates for the arrangement of one or more user interface elements, wherein the one or more prototype templates include rendering information for a second user interface;
generate, based on the arrangement and the one or more prototype templates, one or more tile specifications for the dynamic user experience;
store the one or more tile specifications in a data structure in association with the dynamic user experience; and
transmit, to a client device and based on a client request, the one or more tile specifications to cause the client device to display the dynamic user experience via the second user interface.

2. The system of claim 1, wherein the one or more processors are further configured to:
receive, from the client device, the client request for the dynamic user experience, wherein the client device is configured to display the second user interface, wherein the one or more processors are configured to transmit the one or more tile specifications based on the client request.

3. The system of claim 2, wherein the one or more processors are further configured to:
obtain, from the data structure, the one or more tile specifications based on the client request.

4. The system of claim 1, wherein the one or more processors are further configured to:
perform a validation operation using the one or more tile specifications to determine whether the one or more tile specifications are valid for use.

5. The system of claim 4, wherein the validation operation is based on one or more client capabilities and one or more system capabilities.

6. The system of claim 4, wherein the one or more processors, to store the one or more tile specifications in the data structure, are configured to:
store the one or more tile specifications in the data structure based on the validation operation indicating that the one or more tile specifications are valid for use.

7. The system of claim 1, wherein the one or more processors are further configured to:
provide, for display via the first user interface, one or more interactive user interface elements, wherein the arrangement of the one or more user interface elements is based on a user input to the first user interface associated with the one or more interactive user interface elements.

8. The system of claim 1, wherein the one or more processors, to generate the one or more tile specifications, are configured to:
obtain one or more specification templates based on the one or more user interface elements; and
populate the rendering information in the one or more specification templates to generate the one or more tile specifications.

9. The system of claim 1, wherein the one or more processors are further configured to:
provide, to a device, the one or more tile specifications to cause the dynamic user experience to be displayed via the first user interface.

10. A method for tile specification generation for dynamic user interface tiles comprising:
obtaining, by a system and via a first user interface, an arrangement of one or more user interface elements for a dynamic user experience;
obtaining, by the system, one or more prototype templates for the arrangement of one or more user interface elements, wherein the one or more prototype templates include rendering information for a second user interface;
generating, by the system and based on the arrangement and the one or more prototype templates, one or more tile specifications for the dynamic user experience; and
storing, by the system, the one or more tile specifications in a data structure in association with the dynamic user experience.

11. The method of claim 10, wherein the data structure is included in an experience registration database for the system.

12. The method of claim 10, further comprising:
receiving, from a client device, a client request for the dynamic user experience, wherein the client device is configured to display the second user interface;
obtaining, from the data structure, the one or more tile specifications based on the client request; and
transmitting, to the client device, the one or more tile specifications to cause the client device to display the dynamic user experience via the second user interface.

13. The method of claim 10, further comprising:
performing a validation operation using the one or more tile specifications to determine whether the one or more tile specifications are valid for use, wherein the validation operation is based on one or more client capabilities and one or more system capabilities.

14. The method of claim 13, wherein storing the one or more tile specifications in the data structure comprises:
storing the one or more tile specifications in the data structure based on the validation operation indicating that the one or more tile specifications are valid for use.

15. The method of claim 10, further comprising:
providing, for display via the first user interface, one or more interactive user interface elements, wherein the arrangement of the one or more user interface elements is based on a user input to the first user interface for the one or more interactive user interface elements.

16. The method of claim 10, wherein generating the one or more tile specifications comprises:
obtaining one or more specification templates based on the one or more user interface elements; and
populating the rendering information in the one or more specification templates to generate the one or more tile specifications.

17. A non-transitory computer-readable medium storing a set of instructions, the set of instructions comprising:
one or more instructions that, when executed by one or more processors of a system, cause the system to:
obtain, via a first user interface, an arrangement of one or more user interface elements for a dynamic user experience;
obtain one or more prototype templates for the arrangement of one or more user interface elements, wherein the one or more prototype templates include rendering information for a second user interface;
generate, based on the arrangement and the one or more prototype templates, one or more tile specifications for the dynamic user experience; and
store the one or more tile specifications in a data structure in association with the dynamic user experience.

18. The non-transitory computer-readable medium of claim 17, wherein the one or more instructions further cause the system to:
receive, from a client device, a client request for the dynamic user experience, wherein the client device is configured to display the second user interface;
obtain, from the data structure, the one or more tile specifications based on the client request; and
transmit, to the client device, the one or more tile specifications to cause the client device to display the dynamic user experience via the second user interface.

19. The non-transitory computer-readable medium of claim 17, wherein the one or more instructions further cause the system to:
perform a validation operation using the one or more tile specifications to determine whether the one or more tile specifications are valid for use, wherein the validation operation is based on one or more client capabilities and one or more system capabilities.

20. The non-transitory computer-readable medium of claim 17, wherein the one or more instructions, that cause the system to generate the one or more tile specifications, cause the system to:
obtain one or more specification templates based on the one or more user interface elements; and
populate the rendering information in the one or more specification templates to generate the one or more tile specifications.
